(19) United States
(12) Patent Application Publication
(10) Pub. No.: US 2004/0173946 A1
(43) Pub. Date: Sep. 9, 2004

(54) Process for quality control for a powder based layer building up process

(76) Inventors: Rolf Pfeifer, Boeblingen-Dagersheim (DE); Jialin Shen, Bernstadt (DE); Didier von Zeppelin, Ulm (DE)

Correspondence Address: PENDORF & CUTLIFF, 5111 MEMORIAL HIGHWAY, TAMPA, FL, 33634-7356, US

(21) Appl. No.: 10/795,668

(22) Filed: Mar. 8, 2004

(30) Foreign Application Priority Data
Mar. 7, 2003 (DE) 103 10 385.6-16

(51) Int. Cl. B23K 26/00

(52) U.S. Cl. 264/497; 219/121.6

(57) ABSTRACT

Process for production of three dimensional bodies of particles by a layer buildup process (powder based generative rapid prototyping process), wherein the layer buildup is monitored by an optical control device, which evaluates the light intensity or color differences within and between deposited or hardened particle layers, as well as a suitable optical control device, and further yet, particles or binder liquid particularly suited for optical quality control.

### BACKGROUND OF THE INVENTION

1. Field of Invention

The invention concerns the production of three-dimensional bodies (3D-bodies) made up of particles, using a layer buildup process (powder based generative rapid prototyping process). Therein particle layer defects are identified using an optical control device, are evaluated based thereon, and in certain cases measures for repair of the layer or initiated. The invention further concerns a suitable control device, which includes at least one camera, as well as particles or binder liquids which contain colorants or dies particularly suited for optical inspection.

Among the particularly interesting powder based generative rapid prototyping (RP) processes, there may be mentioned the 3D-binder print process and 3D-laser sintering.

2. Related Art of the Invention

In the case of the 3D-binder printing processes (also 3D-binder printing) a layer of particles or granules is applied upon a substrate and thereupon in predetermined areas, which respectively correspond to a layer or section of the object to be produced, are wetted or moistened with a binder liquid. In general the binder liquid includes adhesives, which bring about a hardening in the desired areas. These processes are known for example from European Patent EP 0644 809 B1, EP 0686 067 B1 and European Patent Application EP 1 099 534 A2.

A further variant of the 3D-binder printing process is known from EP 0 925 169 B1, in which the adhesive is present in the particle layer and is activated by means of an aqueous binder liquid. The adhesive could also be present as a particle coating.

A generative RP process is known from DE 198 13 742 C1, which employs intense electromagnetic radiation, in particular laser radiation, to harden the particle layers in predetermined areas. The particles are sintered by the radiation or, in certain cases, particles are melted. This type of process will be referred to in the following as 3D-laser sintering.

All the above-described processes have in common that the essential quality characteristics of the formed 3D-bodies are directly predetermined by the quality of the applied layer. Quality characteristics of the 3D-bodies include in particular the homogeneity of the density, the particle size distribution, as well as the edge sharpness.

Of particular importance to the process is the quality of the newly applied layer (recoating). The quality characteristics of the recoating include flatness, evenness or homogeneity, as well as the freedom of the layers from brush marks or scoring.

The above described processes have the disadvantage, that neither a quality control of the applied layers, nor repair measures for the particle defect areas, layer defects or construction defects are envisioned.

It is proposed in U.S. Pat. No. 6,492,651 B1 to gauge the layer of the build material using a surface scanner. Therein the scattered light of the illuminated surface zone is used for calculating height signals. Thereupon, the build material can be selectively applied to the locations in which the layer thickness is too small. The particular advantage thereof is that it becomes possible to dispense with the use of a flattening or scraping device for removing excess build material.

In contrast, particularly for the manufacture of very thin layers with correspondingly high image resolution, the use of flattening devices has been found to be very advantageous.

However, the above-discussed layer thickness measurement is not suited for the detection of irregularities in the distribution of particle density, particle size or porosity, as well as for quality control determining quality testing during and following hardening.

### SUMMARY OF THE INVENTION

It is thus the task of the present invention to provide a process which makes possible a quality control of the applied layers prior to or after hardening, and from which repair measures can be derived, and further, to provide particles or binder liquids particularly suited for this process, as well as a suitable control device.

The task is inventively solved by a process for production of three dimensional bodies with the characteristics of Claim 1, by coated particles with the characteristics of Claims 11 or 15, by binder liquids with the characteristics of Claim 13 and a device for production of three dimensional bodies with the characteristics of Claim 16.

The inventive process can be itemized into the following essential process steps, which follow each other repeatedly sequentially:

a) a particle layer of powder material is applied via a dispensing device. The substrate, with the exception of the very first step, is formed by thereunder lying particle layers (recoating).

b) the applied layer is flattened using a flattening device, and in certain cases excess particles are scraped off.

c) the particle layer is hardened in defined areas in a hardening step, whereby further material layers are added to the 3D-body. The hardening can occur either by adhering of the particles under the influence of a binder liquid or by melting or sintering of the particles under the influence of intensive radiation.

In accordance with the invention an optical image of the applied, flattened or hardened layer is taken via the control device. This can occur directly following process steps a), b) and/or c). The image of the layer is so processed in accordance with the invention that defects located in the layer plane, in particular particle defect locations or particle layer defects, as well as construction defects, can be detected. The term particle defect locations is intended to encompass both a surplus as well as shortage of particles in the layer.

A first embodiment of the invention is concerned with the optical examination of a freshly applied particle layer (process step a)). Inhomogeneities in particle dispensing are the most common source of defects typically occurring therein. Thereby there result, among other things, particle hills or particle valleys. The optical examination according this process step makes it possible to introduce a series of corrective measures.

One process variant envisions that the movement of the flattening device is adaptive in subsequent process step b). The flattening device is comprised of a blade or edge, which brushes flat the particle layer; then, for example, the speed of advance in the area of the particle hills can be reduced, in order to facilitate the transport away and the redistribution of excess material.

A further measure which can be derived from the inventive quality control involve the supplemental dispensing of materials into particle valleys, in particular in cavities or holes of the applied layer. This can be carried out for example by a particle conveyor and dispenser device with a focal area or iris. In accordance with the invention supplemental material is applied onto or at least in the immediate vicinity of the blemished areas. The optical detection of the blemished locations makes possible a precise calculation of the needed material.

Likewise it is however also possible to apply a completely new layer (recoating) and to use the flattening device to remove excess applied material over a large surface area.

A further measure is concerned with the bumps or elevations in the applied layer detectable by means of the inventive process. Therein point defects formed by agglomerated particles are in particular of significance. In accordance with the invention measures can be provided, to remove excess particles at, or at least in the immediate vicinity of, the blemish areas or defects. This occurs preferably by means of a blower or vacuum device with a focal area. In certain cases, this device can also be used to remove the entire layer afflicted with blemishes or defects.

The focal area of the particle dispensing device or the blower or vacuum device is preferably in the range of 250 μm to 10 mm.

A further embodiment of the invention is concerned with the optical inspection of the flattened layer, that is, following process step b). A typical source of defect during flattening is brought about by agglomerates or particles which are too large. These are pushed, during brushing flat with the flattening device, through the particle layer and dig furrows or grooves.

A corrective measure for correcting this defect, which measure can be derived from the inventive quality control, is provided by the additional dispensing of powder material, for example by local supplementation or large surface area recoating, in certain cases with subsequent flattening.

A further source of defects is the displacement of an entire area or an entire layer, which can be caused for example by particles adhered to or encrusted on the binder nozzle or, in certain cases, the flattening device.

A further embodiment of the invention is concerned with optical inspection following hardening of the particle layer in defined areas by adhesion, sintering or melting. Here also in simple manner quality control can be undertaken by evaluation of the optical information.

In the case of 3D-binder printing the particle layer is adhered and hardened by the influence of the binder liquid. For this, adhesives may provided in the particle layer, or on the particles or in the binder liquid itself.

Particularly preferred for employment are particles coated with adhesive containing coatings, in which case the binder liquid as a rule is then free of adhesives. Among the adhesives suitable for use in the invention there may be mentioned in particular the organic solvent soluble polymers. The adhesives contain preferably poly(meth)acrylate, polyester, polyolefin, polyvinyl, polystyrene, polyvinyl alcohol, polyurethane, waxes and/or phenol resins. Particularly preferred adhesives are polyvinyl pyrrolidone or polyvinyl butyral.

It is within the scope of the invention to provide the particle layer with colorants. It is important thereby, that the adhesives change their color, color intensity and/or lightness during or subsequent to contact with the binder liquid. The term “color” in the sense of the present invention also includes wavelength ranges in the near UV or IR light. The colorants thus also include for example suited fluorescing dyestuffs.

A first variant envisions the incorporation of crystalline dyestuffs in the coating of the particles, which dye stuffs are soluble in the binder liquid. During moistening by the binder liquid the crystals can be dissolved, whereby the colored surface and therewith the color intensity is conspicuously increased. The particularly suitable dyestuffs include alcohol soluble pigments.

In a further variant the binder liquid undergoes a chemical reaction with the components of the coating, which produces new color carriers. For this, in a simple example, pH indicators can be employed, which are caused to undergo a color reaction upon exposure to acidic or basic binder solvents.

It has surprisingly been found that even the smallest amounts of dyestuffs dissolved in the coating exhibit a conspicuous color intensity change under the influence of the binder liquids. This effect can even be seen with dyestuffs with poor solubility in the binder liquid.

Even pigments insoluble in the binder liquid are partially suited, since they are suspended in the binder liquid and then concentrate preferably in the edge areas of the wetted surfaces. Thereby they develop very sharp color contrasts at the edges or outlines of the moistened areas.

The concentration of the dyestuff in the particle coating is preferably in the range of 0.1 to 20 wt. % (based on the coating).

The above cited dyestuffs can in analogous manner also be present in the powder material as discreet components, that is, not as components of the particle coating. The powder material includes in this case preferably a proportion of 0.001 to 2% of dyestuff.

In a further embodiment of the invention, the binder liquid includes the dyestuffs. In accordance with the invention a change in the color, color intensity and/or lightness of the particle layer is brought about by the binder liquid in the moistened areas. The principles discussed already for the dyestuffs contained in the coating can be applied in analogous manner also to the coloring by means of dyestuff containing binder liquids.

The binder liquids preferably include organic solvents, such as C2- to C7-alcohols, in particular ethyl alcohol, (iso) propanol or n-butanol, C3- to C8-ketones, such as for example acetones or ether-ketone-cyclic ethers such as tetrahydrofuan or polyethers such as methoxyethanol, dimethoxydiethylene glycol or dimethoxytriethyleneglycol. The dyestuffs preferably exhibit a good solubility in the corresponding solvent.

A suitable concentration of the dyestuff in the binder liquid is in general in the range of fro 0.05 to 2 wt. %.

In the case that insoluble color pigments are to be employed, then their content in the binder liquid is preferably in the range of 0.1 to 4 wt. % in particularly preferably below 2 wt. %.

In a further variant, dyestuffs are employed in the binder liquid which react with components of the particle layer, in particular with components in the coating of the particles, which result in changes in color. For example, as dyestuffs pH indicators can be considered for employment, which react with acids or bases contained in the particle coating. This procedure has the advantage that not only an inspection of the moistening can occur but rather also the effect or intensity of the moistening can be observed.

In a further embodiment of the invention the binder liquid contains light-hardenable monomers or oligomers. For this, for example, methacrylates or acrylic acid derivates are particularly suited. The hardening of the moistened layer is carried out using irradiation, particularly UV-light.

It is in particular possible in accordance with the inventive process of optical inspection to detect areas with insufficient moisture and in certain cases to re-apply binder liquid. Likewise, in the case of 3D laser sintering a targeted or precise post-sintering can be carried out.

Among the typical defects, which can occur during 3D binder printing, there are included layer misalignment or off-set, for example by an erroneously calculated trajectory curve for the liquid droplets from the moving nozzle exit, or a lost line, which can be caused by a plugged printer nozzle. With the inventive process for optical inspection these defects can be reliably detected and, in certain cases, be repaired by corrective deployment of the printer head.

Changes in process conditions brought about by environmental influences such as temperature, humidity or sunlight are the main causes of optical defects during the build-up of the 3D-body. An elevated temperature of the particle layer leads, during moistening of the areas for example to a more rapid evaporation of binder solvent, which in general can be optimally conspicuously recognized. Thus the inventive inspection device is suited, to a certain extent, to recognize and introduce appropriate counter-measures in response to the changing process conditions.

In the case of hardening of the particle layers by means of intensive electromagnetic radiation, in particular laser radiation as used in 3D-laser sintering, a yet further color effect can be used for optical inspection. The inventive color effect is brought about by dyestuffs which darken or, in certain cases, blacken under the heat effect of the radiation.

It is within the scope of the invention to incorporate as components of the particle layer, in particular as components of a particle coating, organic polymers which decompose under the thermal influence of the radiation, or are pyrolyzable or carbonizable. These include in particular organic resins or duromers.

It is essential therein, that the thermal decomposition, pyrolysis or carbonization results in a darkening or blackening of the substances. Depending upon the intensity of the radiation a yellowing, browning or blackening of the irradiated areas can be observed. This darkening or blackening is typical for most organic polymers under the influence of heat. This involves the cleavage of volatile organic substances, the formation of aromatic areas and in particular a beginning of coking of the material. Particularly suited polymers exhibit a high proportion of aromatics. These include for example phenol resins, aromatic polyesters and polyamides.

The evaluation of the organic image of the hardened layer can be used to post-harden specific areas. This can be carried out particularly efficiently in the case of the laser process.

By nature, the possible repair measures following hardening are however less than in the case of application or brushing flat of the just applied layer. This concerns in particular surplus hardened material, wherein a correction is no longer possible. Even in this case the inventive quality control provides a substantial advantage, since the buildup of the 3D-body can be terminated early enough, whereby process time and material is saved.

It can easily be seen that the inventive process is particularly efficient in the case of a particularly high color contrast or light intensity contrast between dyestuff and powder material.

Accordingly it is particularly preferred to use lightly colored, colorless or white powder materials.

Ceramics employable as the powder material generally exhibit only a small inherent coloration. Particularly suited are oxidic ceramics, for example based upon the elements B, Al, Si, Al, Ti, Zr, Mg and/or Ca.

In the case of colored ceramics, in particular black ceramic, such as for example TiC, TiN, SiC or Si₃N₄, it is preferred to employ fluorescing dyestuffs as the colorant.

The plastics employed for generative RP-processes also exhibit in general only a low inherent colorization and are thus particularly suited for the inventive process.

In the case of metallic powders the contrast between colorant and powder layer is more difficult to establish.

During 3D-laser sintering it is preferred to employ the thermal decomposing polymers as the colorants. During hardening of the layer there occurs in general a noticeable reduction in the metallic sheen of the powder particles, leading to a matt gray and in certain cases black. The signal which can be optically evaluated is, in this case, the light intensity or lightness.

Suitable metal powders include in particular the metallic, alloy and intermetallic phases of elements of the group Al, Fe, Mo, Cr, W, Cu, Ag, Au, Sn, Pt and/or Ir.

In the case of intensive inherent coloration of the powder material it can be useful to employ fluorescing dyestuffs as the colorant, since they develop their luminosity outside the range of the inherent coloration of the powder material.

A further aspect of the invention concerns a device for generative rapid prototyping with an inspection or control device in the form of an optical image taking system.

### BRIEF DESCRIPTION OF THE DRAWINGS

A preferred embodiment in which the process variant is a 3D-binder printing is described in greater detail on the basis of the schematic diagram of FIG. 1.

There is shown:

FIG. 1 a schematic diagram of a 3D-binder printing system in side view, including a powder reservoir (1), a dispensing gap (2), a powder conveyor unit (3), a conveyor edge (4), individual particles (5), a print nozzle (6), cameras (7, 7′), a flattening device (8), the blade edge of the flattening device (9), a flattened powder layer (10), a powder dispensing device with its own focal area (11), 3D-body or adhered powder particles (12) and a particle defect site (13).

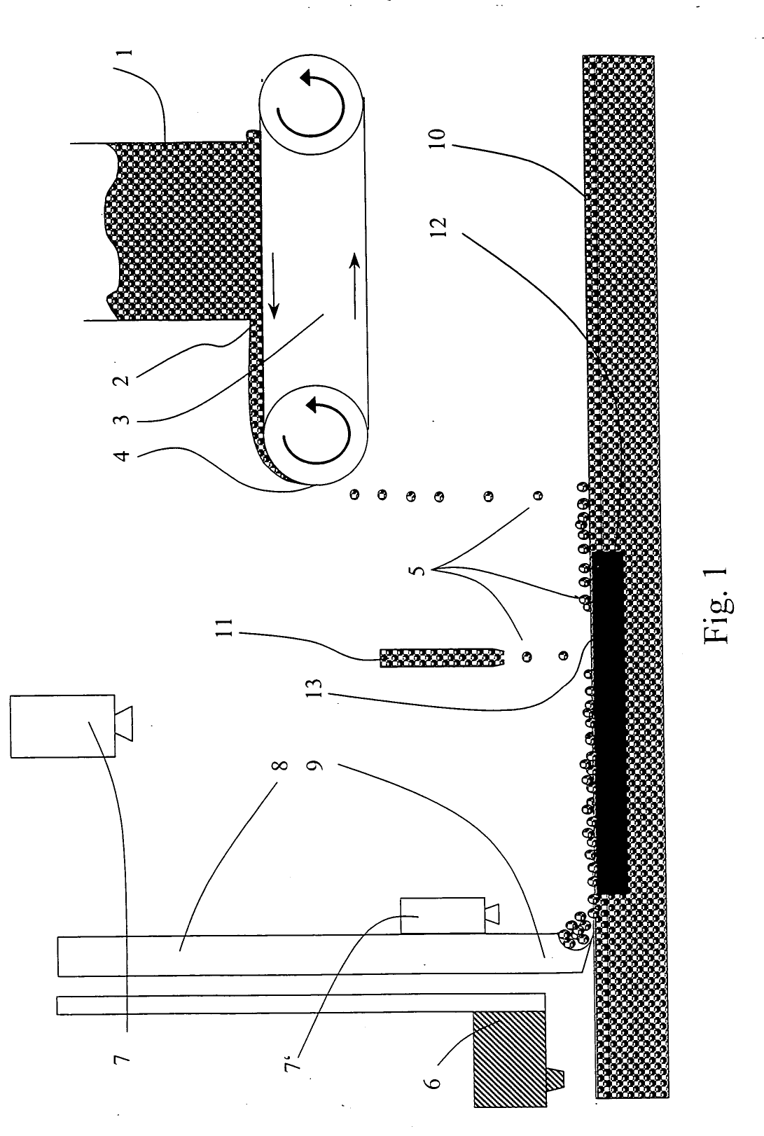

### DETAILED DESCRIPTION OF THE INVENTION

As a first element of the recoating system a particle delivery device is provided, which includes as components the powder reservoir (1), dispensing gap (2), powder conveyor unit (3), and conveyor edge (4). The powder material is stored in the powder reservoir and dispensed upon the conveyor unit (3). Therein the dispensing or metering preferably occurs via a dispensing gap (2) which is formed by a limiting surface of the powder container and the powder conveyor unit. The conveyor unit extends over the entire breadth of the powder layer to be formed. The gap can in certain cases be extended in the conveyance direction by a limiting surface or a cover sheet. The conveyance of the powder is accomplished by a conveyor belt. The powder leaves the conveyor unit at a conveyor edge (4). Thereafter the particles (5) can fall unimpeded upon the substrate or, as the case may be, the already formed powder bed. In the schematic diagram aggolomerates of smaller primary particles are shown as particles (5). The represented particle layer exhibits a particle defect site (13), in which no particles are deposited. The flattening device (8) is passed over the particle layer, whereby the particle layer is brushed flat by a blade (9), which is preferably electrically insulated. The blade preferably extends over the entire breadth of the powder layer. The blade edge (9) is preferably so designed, that the blade pushes the powder ahead of it in a rolling movement. This is accomplished for example by adjusting to an appropriate angle of attack and a rounding the blade edge (9) depending upon the particle size.

The flattened layer (10) is moistened with binder liquid via a print head (6). The print head is thereby moved over two axis. By the adhesion and hardening of defined areas of the powder layer, the 3D-body is built up (12).

The total area of the 3D-body is optically surveyed by a camera (7) during the individual stages of the process. A second camera (7′) is provided on the moveable flattening device. It scans the area directly ahead of the blade (9).

The dispensing device with its own focal area is guided over the defect site (13) and dispenses here a precisely targeted amount of the particles (5). This process is directly controllable optically via the camera (7).

For taking or recording the image of the particle layer or, as the case may be, the hardened areas, one or more cameras can be provided. The image can be an individual image or it can be a composite of multiple individual images. For this the at least one camera can be fixed or moveable. One camera can be, for example, a scanner which is guided over the surface of the particle layer. Preferably one camera which is a scanner is mounted directly on the flattening device. Therein it can be useful when a camera is so provided to cover, or the field of view of the camera covers, the area ahead of as well as behind the direction of movement of the flattening device.

Preferably at least one camera is provided of which the field of view encompasses the entire area of the 3D object to be formed.

The high color or light intensity contrast between the moistened or hardened areas on the one hand, and the untreated particle layer on the other hand, achievable in accordance with the invention makes it possible to employ a conventional digital camera.

A further embodiment of the invention is concerned with one of the most frequent recoating defects—the formation of furrows—which run through the layer in a straight line perpendicular to the orientation of the flattening device. These furrows are typically caused by particles which are too large and rough and are dragged by the flattening device across the freshly applied layer.

These furrows can be optically detected by a beam projector with sideways introduction of light. At the site of the furrows the beam lines of the light source are interrupted or make a conspicuous bend. These optical patterns can be much better resolved by the camera then the furrows themselves. For this reason it becomes possible to dispense with high resolution camera sensors or special magnification lenses. The evaluation of the optical signals is also comparatively simple.

In a further embodiment two cameras are employed which are spaced apart from each other so far that their images can be superimposed to form a three dimensional image. This has the advantage that depth information is also available for the detected defect sites. This data can be drawn upon in particular for generating more precise calculation of the corrective measures to be carried out. Thus it becomes possible to calculate for example the amount of the particles to be provided by the dispensing device (11). In the case of constant particle conveyor speed of the dispensing device (11) the amount of the particle to be supplied can be adjusted by varying the speed with which the dispensing device is guided over the substrate.

The nozzles of the particle dispensing device or the blower or vacuum device are preferably controlled via a robot arm.

It is particularly preferred to provide the particle dispensing device or the blower or vacuum device directly at the print head such that they are moved along with it.

A further advantage of the invention is that the optical data collected over multiple recoating cycles can be allowed to accumulate and automatically evaluated. Both the image of the individual layer as well as in particular the accumulated data are so evaluated in accordance with the invention such that, automatically, suitable measures can be initiated such as for example defect correction by renewed recoating and hardening, or even the interruption of the buildup process for a manual intervention. Neuronal networks are particularly preferably employed in order to draw thresholds between acceptable and no longer acceptable defects.

The evaluation of cumulative images or their data makes defects recognizable which build up perpendicular to the particle layer only after multiple layer planes. In this way, for each formed 3D-image it becomes possible to produce simultaneously a complete 3D-image of its internal buildup or constitution. This can be of substantial importance to a comprehensive quality control. This applies not only for a 3D-binder print, but rather also for all other process variants encompassed by the invention.

For the evaluation of the images it can in certain cases sufficient, instead of an overall image of the surface of the 3D-body, to sample only a few test sites at particular coordinates on the surface, upon which sites the geometry of the body is dependent.

1. Process for producing three dimensional bodies including the multiple succession of the steps
a) applying a layer of particles, via a dispensing device, upon a substrate
b) flattening the applied layer with a flattening device
c) hardening the layer by adhesion of the particles with introduction of binder liquid or hardening the layer by melting or sintering the particles under the influence of intensive radiation in defined areas within the layer, thereby characterized,
that after steps a), b) and/or c) an optical image of the applied, flattened and/or hardened layer is recorded, wherein the image is suited for revealing particle defect sites located in the layer plane or particle layer defects.

2. Process according to claim 1, thereby characterized, as a result of step c) a change in the lightness and/or the color is brought about in defined areas.

3. Process according to claim 2, thereby characterized, that the binder liquid used for adhering the particles includes colorant.

4. Process according to claim 2, thereby characterized, that the particles contain colorant, which changes in color and/or lightness upon exposure to binder liquid.

5. Process according to one of the preceding claims, thereby characterized, that the evaluation of the image intensity and/or color of the image reveals particle defect locations or particle layer defects, from which corrective measures can be derived.

6. Process according to claim 1, thereby characterized, following the revolution of the particle defect sites or particle layer defects, between steps a) and c) additional particles are applied at or in the vicinity of the defect sites or upon the entire particle layer.

7. Process according to claim 6, thereby characterized, that the additional particles are applied by a dispensing device with its own focal area.

8. Process according to claim 1, thereby characterized, that following the revolution of the particle defect sites or particle layer defects, between steps a) and c) particles are removed at or in the vicinity of the defect location or the entire particle layer is removed.

9. Process according to claim 8, thereby characterized, that the particles to be removed are removed by a blower or a vacuum device with a focal area.

10. Process according to claim 1, thereby characterized, the image or memory map is used for a new determination of the defined area of the adhesion, melting or sinter in step c).

11. Coated particles for producing three dimensional bodies with a generative rapid prototyping process with utilization of binder liquids, which cause hardening of particle layers in defined areas, thereby characterized, that the coating of the particles contains a dyestuff soluble in the binder liquid.

12. Particle according to claim 11, thereby characterized, that the coating includes substances, which change their color under the influence of binder liquid.

13. Binder liquid for producing three dimensional bodies by means of a generative rapid prototyping process with use of particle layers which are hardenable in defined areas by a binder liquid, thereby characterized, that the binder liquid contains dyestuffs.

14. Particles according to claim 13, thereby characterized, that the binder liquid includes substances which change their color under the influence of the particles or during the hardening reaction of the particles.

15. Coated particles for producing three dimensional bodies by means of a generative rapid prototyping process which utilization of laser radiation, which causes melting or sintering of particle layers in defined areas, thereby characterized, that the coating is decomposed by the laser radiation at least partially with darkening.

16. Device for producing three dimensional bodies with at least one generative rapid prototyping process, including
a particle reservoir
a flattening device
a hardening device and
a control device, thereby characterized, that the control device includes at least one camera, with which an optical image of the entire surface of the 3D-body to be generated is reproducible.

17. Device according to claim 16, thereby characterized, that at least two spaced apart cameras are provided, of which the individual images can be assimilated into a joint three dimensional image.

18. Device according to claim 16, thereby characterized, that at least one beam projector is provided, which eliminates the applied layer in strips.

19. Device according to claim 16, thereby characterized, that the hardening device includes at least one print nozzle for binder liquid.

20. Device according to claim 16, thereby characterized, that the hardening device is a laser light source.

21. Device according to claim 16, thereby characterized, that the hardening device is a UV-spot radiator or an electron emitter.
